(19) United States
(12) Patent Application Publication
(10) Pub. No.: US 2005/0107046 A1
(43) Pub. Date: May 19, 2005

(54) Modular mobile telephone apparatus

(75) Inventors: Gus Desbarats, Farnham (GB); Robert Day, Royston (GB); Piers Harding, Royston (GB); Jonathan Kemp, Royston (GB); James Wehbeh, Royston (GB)

Correspondence Address: NIXON & VANDERHYE, PC, 1100 N GLEBE ROAD, 8TH FLOOR, ARLINGTON, VA, 22201-4714, US

(73) Assignee: BRITISH TELECOMMUNICATIONS public limited company

(21) Appl. No.: 10/497,313

(22) PCT Filed: Dec. 16, 2002
(86) PCT No.: PCT/GB02/05701

(30) Foreign Application Priority Data
Dec. 17, 2001 (GB) 0130128.2
Sep. 2, 2002 (GB) 0220331.3

(51) Int. Cl. H04B 1/38; H04B 1/08; H04M 1/00

(52) U.S. Cl. 455/90.3; 455/575.1; 455/347

(57) ABSTRACT

A mobile telephone is provided that comprises: a core functional module, which includes one or more of a group of functional components necessary for operation as a mobile telephone, the group including logic circuitry, radio transmitting and receiving circuitry and audio transmitting and receiving circuitry, and a casing module which can be combined with the core functional module, wherein circuitry is associated with the casing module and wherein when the core functional module is combined with the casing module, the circuitry of the core functional module will be connected to circuitry associated with the casing module. The mobile telephone is characterised in that the appearance of the mobile phone is dictated by the appearance of the casing module, and the functionality of the mobile phone is dictated by the circuitry of the core module and the circuitry associated with the casing module.

### TECHNICAL FIELD

This invention relates to a modular mobile telephone apparatus.

### BACKGROUND TO THE INVENTION

There are many designs of mobile telephones available. At any one time, a particular mobile telephone manufacturer may have a range of different models of mobile telephone which differ in terms of function. For example, one model may offer playback of MP3 music files whilst another may provide a camera capable of taking digital photographs. A given model of mobile telephone will also have a series of options which can be set by a user to determine the manner in which the telephone will operate. These include options such as the ring tone, whether there is a vibrating call alert, whether calls are diverted and so forth. For any given model, there may also be a limited range of appearance options. In one known system, it is possible to change the appearance of the outer casing of the mobile telephone by replacing the original outer casing with a new one of a different colour.

### SUMMARY OF THE INVENTION

According to a first aspect of the present invention there is provided a mobile telephone comprising: a core functional module, said core functional module including one or more of a group of functional components necessary for operation as a mobile telephone, said group including logic circuitry, radio transmitting and receiving circuitry and audio transmitting and receiving circuitry, and a casing module which can be combined with the core functional module, wherein circuitry is associated with the casing module and wherein when the core functional module is combined with the casing module, the circuitry of the core functional module will be connected to circuitry associated with the casing module, and wherein the appearance of the mobile telephone is dictated by the appearance of the casing module, and wherein the functionality of the mobile telephone is dictated by the circuitry of the core module and the circuitry associated with the casing module.

In this way, a greater versatility is provided in terms of creating different models of mobile telephone and in terms of customising mobile telephones.

In preferred embodiments the casing module can be combined with the core functional module by inserting the core functional module into the casing module. In this way, the process of combining the core functional module with the casing module is easier (from the point of view of a user) since the user merely has to push the core functional module into the casing module and does not need to follow any complex alignment techniques.

Preferably, when the core functional module is combined with the casing module, the casing module surrounds the core functional module preferably on at least four sides of said core functional module. In this way the core functional module is protected from any damage that may be caused to it by exposing it to shock. This is important since the core functional module is likely to be more expensive to replace than a casing module and so damage to the casing module, although not desirable, is preferable to damage to the core functional module. Furthermore, by enclosing the core functional module within a casing module, the mobile telephone maintains the mechanical integrity of known, existing mobile telephones. In other preferred embodiments the casing module may envelop the core functional module thus protecting it from exposure to the environment. In this way it is possible to provide a mobile telephone that is shock and water resistant.

In preferred embodiments the appearance of the mobile telephone is substantially dictated by the appearance of the casing module. In this way it is possible to completely change the external appearance and shape of the mobile telephone. Thus, for example, mobile telephones for different users (e.g. adults/children) or different uses (e.g. business use/adventure use) can appear different. Moreover, the mobile telephone can be used in differing orientations depending on which casing module is being used and what functionality is desired. In other embodiments the appearance of the mobile telephone is solely dictated by the appearance of said casing module. This will be the case when the core functional module is enclosed within a casing module as described above.

Preferably the core functional module is spring-loaded in the casing module. This facilitates the separation of the core functional module from the casing module since the core functional module will be forced out of the casing module enabling a user to grip the end of the core functional module in order to separate the two modules. This is advantageous since the user will not have to shake the mobile telephone in order to separate the two modules thus again preventing any damage caused to the mobile telephone by shock. This is also particularly advantageous when the casing module surrounds the core functional module.

In preferred embodiments the circuitry of the core module and/or the circuitry associated with the casing module restricts the functionality of the mobile telephone. This is advantageous to a parent wishing to restrict their child's usage of a mobile telephone or to a business wishing to restrict an employees usage of a mobile telephone.

According to another aspect of the present invention there is provided a casing module for a mobile telephone, the casing module being adapted to cooperate with a core functional module, the core functional module including one or more of a group of functional components necessary for operation as a mobile telephone, said group including logic circuitry, radio transmitting and receiving circuitry and audio transmitting and receiving circuitry, wherein circuitry is associated with the casing module and wherein the casing module can be combined with the core functional module to create a mobile telephone, and wherein when the casing module is combined with the core functional module the circuitry associated with the casing module will be connected to circuitry of the core module, and wherein the appearance of the mobile phone is dictated by the appearance of the casing module, and the functionality of the mobile phone is dictated by the circuitry of the core module and the circuitry associated with the casing module.

In this way, a variety of casing modules can be individually combined with a single core functional module providing mobile telephones with differing functionalities. A greater versatility is therefore once again provided in terms of creating different models of mobile telephones and in terms of customising mobile telephones. If a particular functionality was required or no longer required, or if a particular casing module became damaged, a user could simply replace the casing module while keeping the same core functional module.

According to another aspect of the present invention there is provided a core functional module for a mobile telephone, the core functional module including one or more of a group of functional components necessary for operation as a mobile telephone, said group including logic circuitry, radio transmitting and receiving circuitry and audio transmitting and receiving circuitry, wherein the core functional module can be combined with a casing module to create a mobile telephone, and wherein when the core functional module is combined with the casing module, the circuitry of the core functional module will be connected to circuitry associated with the casing module, and wherein the appearance of the mobile telephone is dictated by the appearance of the casing module, and the functionality of the mobile phone is dictated by the circuitry of the core module and the circuitry associated with the casing module.

In this way, a single core functional module can be individually combined with variety of casing modules providing mobile telephones with differing functionalities. A greater versatility is therefore once again provided in terms of creating different models of mobile telephones and in terms of customising mobile telephones. If a particular functionality was required or no longer required, or if a particular casing module became damaged, a user could simply replace the casing module while keeping the same core functional module.

According to another aspect of the present invention there is provided an interconnect mechanism comprising a first member and a second member, the first member and/or second member being movable in a respective direction with respect to the other to an interconnected position wherein the first member is interconnected with the second member and then subsequently to a release position wherein the first and second members are releasable from each other.

In this way, an interconnect mechanism that is more intuitive to use than existing, known interconnect mechanisms is provided. A user operating the interconnect mechanism pushes the mechanism to enable it and pushes further, in the same direction, to release it.

In a preferred embodiment, in use, the first member and/or second member move directly to the interconnected position without moving beyond the interconnected position.

In a preferred embodiment, the interconnect mechanism provided by the present invention is used in combination with the mobile telephone, core functional module and casing module provided by the other aspects of the invention to connect a core functional module to a casing module to provide a mobile telephone.

According to another aspect of the present invention there is provided a mobile telephone comprising a core functional module which includes the functional components necessary for operation as a mobile telephone including logic circuitry, radio transmitting and receiving circuitry and audio transmitting and receiving circuitry, and a removable casing module in which the core functional module is received, characterised in that circuitry is associated with the casing module and is connected to circuitry of the core module, so that the appearance of the mobile phone is dictated by the appearance of the casing module, and the functionality of the mobile phone is dictated by the circuitry of the core module and the circuitry associated with the casing module.

According to another aspect of the present invention there is provided a method for creating a mobile telephone in which a core functional module is provided which includes the functional components necessary for operation as a mobile telephone including logic circuitry, radio transmitting and receiving circuitry and audio transmitting and receiving circuitry, and there is provided a casing module which is combined with the core functional module to create a complete mobile telephone, characterised in that circuitry is associated with the casing module and when the casing module is combined with the core functional module the circuitry associated with the casing module is connected to circuitry of the core module, so that the appearance of the mobile phone is dictated by the appearance of the casing module, and the functionality of the mobile phone is dictated by the circuitry of the core module and the circuitry associated with the casing module.

According to another aspect of the present invention there is provided a core functional module for a mobile telephone, the core functional module including functional components necessary for operation as a mobile telephone including logic circuitry, radio transmitting and receiving circuitry and audio transmitting and receiving circuitry, and the core functional module being adapted to cooperate with a casing module so that the casing module can be combined with the core functional module to create a complete mobile telephone, characterised in that circuitry in the core functional module is adapted to be connected to and to cooperate with circuitry associated with the casing module so that when the casing module is combined with the core functional module the functionality of the resultant mobile phone is dictated by the circuitry of the core module and the circuitry associated with the casing module.

According to another aspect of the present invention there is provided a casing module for a mobile telephone, the casing module being adapted to cooperate with a core functional module which includes the functional components necessary for operation as a mobile telephone including logic circuitry, radio transmitting and receiving circuitry and audio transmitting and receiving circuitry, so that the casing module can be combined with the core functional module to create a complete mobile telephone, characterised in that circuitry is associated with the casing module so that when the casing module is combined with the core functional module the circuitry associated with the casing module will be connected to circuitry of the core module, so that the appearance of the mobile phone is dictated by the appearance of the casing module, and the functionality of the mobile phone is dictated by the circuitry of the core module and the circuitry associated with the casing module.

### BRIEF DESCRIPTION OF THE DRAWINGS

Further features and advantages of the present invention will become apparent from the following description of an embodiment thereof presented by way of example only, with reference to the accompanying drawings, wherein like reference numbers refer to like parts, and in which:

FIG. 1 is a view of the front of a core functional module;

FIG. 2 is a cross section view of the core functional module along the line AA in FIG. 1 in the direction of the arrows;

FIG. 3 is a view of the side of core functional module along the line AA in FIG. 1 in the direction of the arrows;

FIG. 4 is a view of the rear of a core functional module;

FIG. 5 is a view of the front of a casing module;

FIG. 6 is a cross section view of the casing module along the line BB in FIG. 5 in the direction of the arrows;

FIG. 7 is a view of the rear of a casing module;

FIG. 8 is a view of the side of a casing module along the line BB in FIG. 5 in the direction of the arrows;

FIG. 9 is a view of the core functional module inserted into a casing module;

FIG. 10 is a perspective view of a mechanism to connect a core module to a casing module;

FIG. 11 is a perspective view of a further mechanism to connect a core module to a casing module;

FIGS. 12, 13 and 14 show the various stages of operation of the mechanism of FIG. 11;

FIG. 15 is a flow chart showing the stages of operation when a core module is inserted into a casing module;

FIG. 16 shows part of a mechanism for connecting the core module to a casing module;

FIGS. 17 to 20 show the various stages of operation of a mechanism for connecting the core module to a casing module;

FIGS. 21 to 24 show the various stages of operation of a mechanism for connecting the core module to a casing module;

FIGS. 25 to 26 show the various stages of operation of a mechanism for connecting the core module to a casing module;

### DESCRIPTION OF THE EMBODIMENT

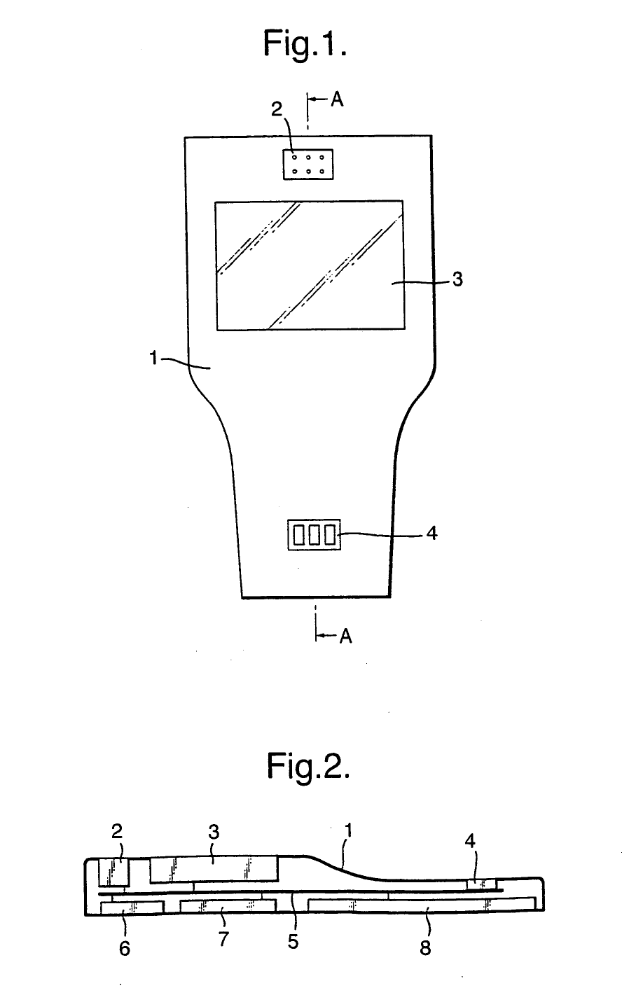

Referring to FIG. 1, there is shown a core functional module for a mobile telephone in accordance with an embodiment of the present invention. The core module comprises a housing 1, having a front face, a rear face and upper, lower and side walls. The front and rear faces each taper smoothly approximately halfway along the length thereof, such that one end of each face is wider than the opposite, distal end. Moreover, the front face comprises a first planar surface proximal the wide end and a second planar surface proximal the narrower end of the faces. The first and second planar surfaces are joined by an interconnecting curved portion. The rear face is planar across its entire surface. The upper, lower and side walls are disposed between the front and rear faces which are arranged in alignment and parallel to each other. As a consequence, the upper and lower walls are rectangular in shape, although of different sizes; the upper wall being of greater width and height than the lower wall. The side walls each comprises first and second planar portions joined by an interconnecting curved portion. The first planar portion is located adjacent the wide end of the front and rear faces and is itself of greater width than the second planar portion of each side wall. The effect of this is that the housing 1 tapers in two planes such that the wide end of the housing is also of greater depth than the narrower end.

At the wide end of the housing 1, on the front face there is an earpiece/speaker 2. Below the earpiece/speaker 2 there is a rectangular display 3 (e.g. a graphics capable, colour, liquid crystal display (LCD)) and near the bottom end there is an electrical connector 4. Backlighting is provided to the display 3 (e.g. by LED) and the display 3 supports all the major common open formats (e.g. GIF, JPG). The connector 4 will connect the electrical components of the core module to those in a casing module. The casing module itself and the electrical connection between the core module and casing module will be described in more detail below. The earpiece/speaker 2, display 3 and connector 4 are all situated within the housing 1 but are visible and accessible through apertures on the front face of the housing 1.

With reference to FIG. 2, within the housing 1, the earpiece/speaker 2, display 3 and connectors 4 are all connected to a printed circuit board (PCB) 5 that runs through the middle of the housing from near the wide end to near the narrow end. At the wide end of the housing 1, on the internal rear face there is an antenna 6 and below the antenna 6 is an incoming call/message alerting device 7. Preferably the device 7 can be configured in an audible mode for audible alerts preferably using a polyphonic tone generator. Preferably, the device 7 also has a selectable vibrating alert for silent identification of incoming calls or messages. On the external rear face of the housing at the narrow end there is a hollow in which there is situated a battery 8. The battery 8 can be removed. Removal of the battery 8 provides access to a slot (not shown) for a subscriber identity module (SIM) card. Data can be stored on the SIM card. The data stored on the SIM card is similar to the data stored on SIM cards found in known mobile telephones (e.g. Short Message Service (SMS) messages, call registers, phonebook, Personal Identification Number (PIN) and other subscriber related information). The battery is connected to the PCB 5. Also connected to the PCB 5 (but not shown) are electrical components for logic functions, radio transmitting and receiving circuitry (e.g. the “GSM/GPRS Digital Baseband Processor” available from Analogue Devices, Inc as part number AD6526, which can support GSM and GPRS operation and includes an ARM7TDMI® control processor), audio transmitting and receiving circuitry and memory. The memory can store a phonebook and other phone and call settings like known mobile telephones. It can also further provide software functions (e.g. games, personal information manager, calculator, stopwatch, countdown timer, clock and date), store the identity of the current casing module ID, store default interface functionality data and store cached casing module personality data uploaded from the current casing module. (Casing module personality refers to the visual and audible characteristics of the user interface that is associated with the casing module's physical appearance and becomes active when a core functional module is inserted into the casing module and the device is powered on.) SMS and Enhanced Message Service (EMS) requirements are preferably supported as specified in 3G TS 23.040 Release 5. The Multimedia Messaging Service (MMS) is also preferably supported as specified in 3G TS 23.140 Release 5.

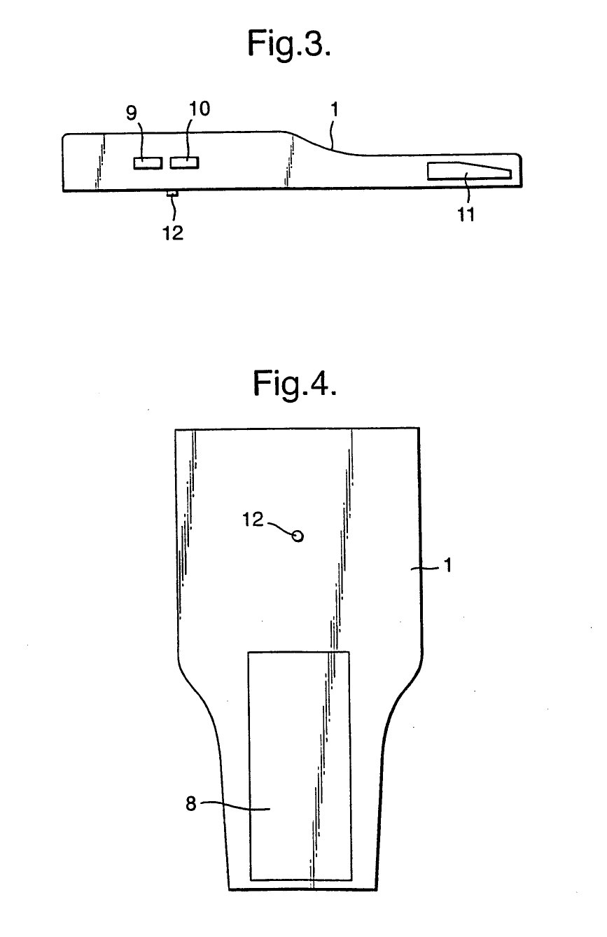

Referring to FIG. 3, approximately a quarter of the way down one of the side walls of the housing are two volume control switches 9 and 10 for controlling the volume of the earpiece/speaker 2. The volume control switches are connected to the PCB 5. A headset jack (not shown) is located in a corresponding position on the opposite side of the housing. On the same side as the volume control switches but at the narrow end of the housing and extending towards the wide end of the housing is a stepped track 11. The stepped track is part of the mechanism that will enable the core module to be connected securely to a casing module and will be described in more detail below.

Referring to FIG. 4, approximately a quarter of the way down the rear side of the housing from the wide end, and extending perpendicularly outwards from the plane of the rear face of the housing is a small cylindrical stud 12. The stud is part of a further mechanism that will enable the core module to be connected securely to a casing module and will be described in more detail below.

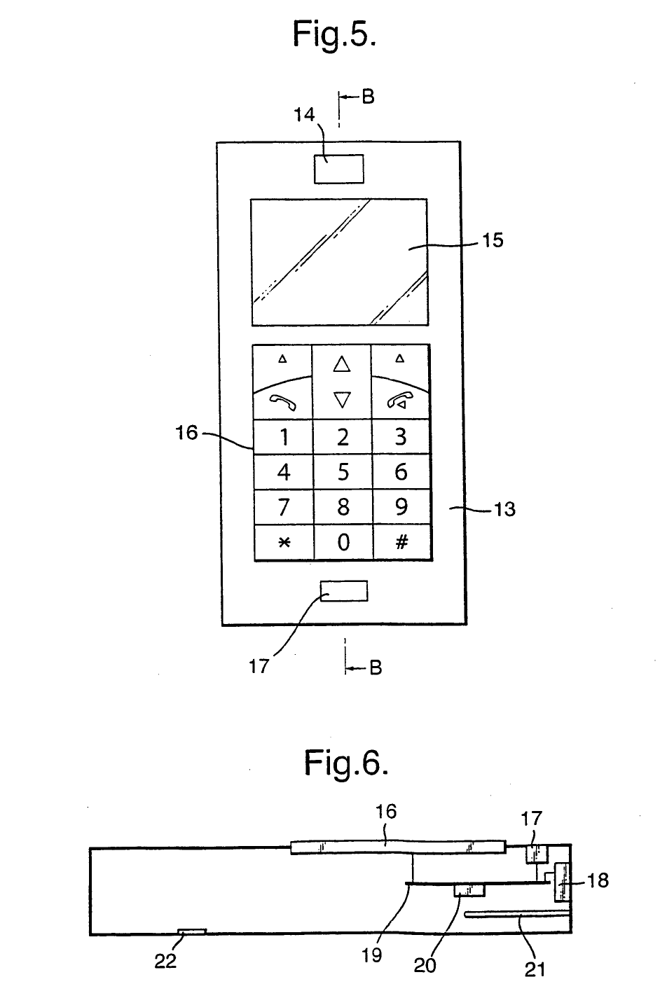

Referring to FIG. 5, there is shown an example of a casing module for a mobile telephone in accordance with an embodiment of the present invention. The casing module comprises a housing 13 having a front face, rear face and upper, lower and side walls. The housing 1 of the core module can be inserted into the housing 13 of the casing module, in a longitudinal direction, through a slot (not shown) on the upper wall of the housing 13. At the end proximal the upper wall and on the front face of the housing 13 is an aperture 14 and below the aperture is a rectangular window 15. When the core module is securely located within the casing module, the aperture 14 lies directly over the earpiece/speaker 2 of the core module and the window lies directly over the display 3 of the core module. Below the window 15 is a keypad 16 and below the keypad 16 is a microphone 17. The keypad 16 is preferably backlit as part of the backlighting provided to the display 3. The keypad 16 and microphone 17 are situated within the housing 13 but are visible and accessible through apertures on the housing 13.

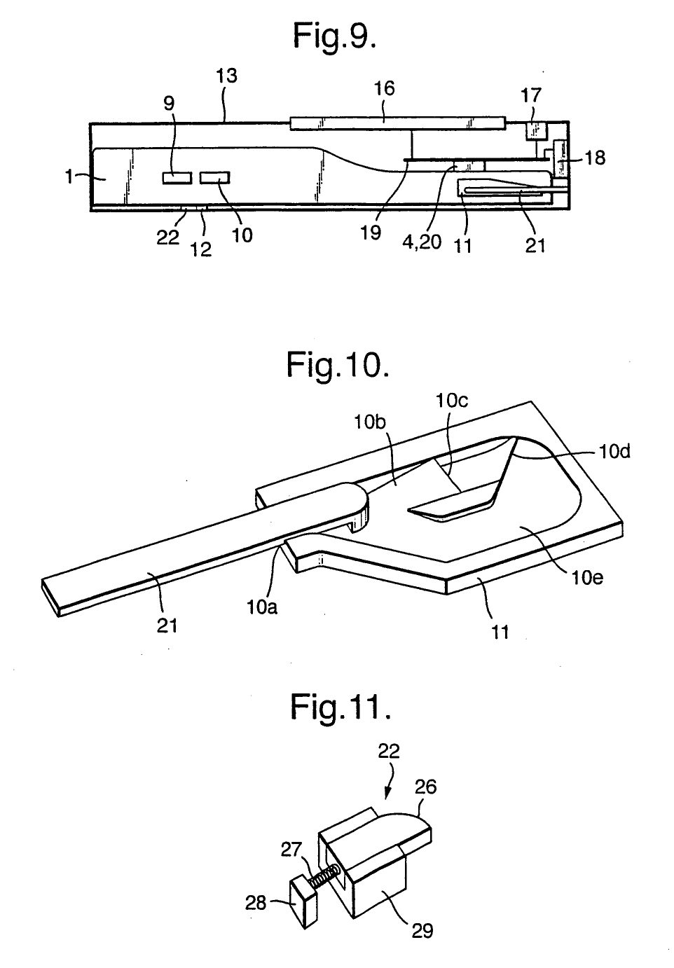

Referring to FIG. 6, on the lower wall of the housing 13 is an accessory port 18. The accessory port 18 provides ports for connecting the complete mobile telephone to a range of accessories. Examples of such ports include a port for a battery charger, hands free kit or car kit, a data port (e.g. a serial data port and/or a Universal Serial Bus (USB) port), a regulated power output port and audio input and output ports. In preferred embodiments, it is possible to connect the battery charger independently of other accessories. The accessory port 18 is situated within the housing 13 but the ports it provides are visible and accessible through an aperture on the housing 13. Extending longitudinally up the middle of the housing from just above the accessory port 18 to approximately one third of the way along the housing 13 from the lower wall is a PCB 19. The keypad 16, microphone 17 and accessory port 18 are all connected to the PCB 19. Also connected to the PCB 19 are connectors 20 for connection to the connectors 4 of the core module. Referring to FIG. 9, when the core module is securely located within the casing module, the connectors 4 of the core module are in contact with the connectors 20 of the casing module enabling the electrical connection between the two modules. Referring again to FIG. 6, also connected to the PCB 19 (but not shown) are electrical components for logic functions. In some embodiments, some memory is also connected to the PCB 19 preferably in the form of one or more integrated non-volatile memory chips. The memory can provide additional software functions, copy protection information, information relating to the relationship between the casing module and the core functional module and casing module personality data.

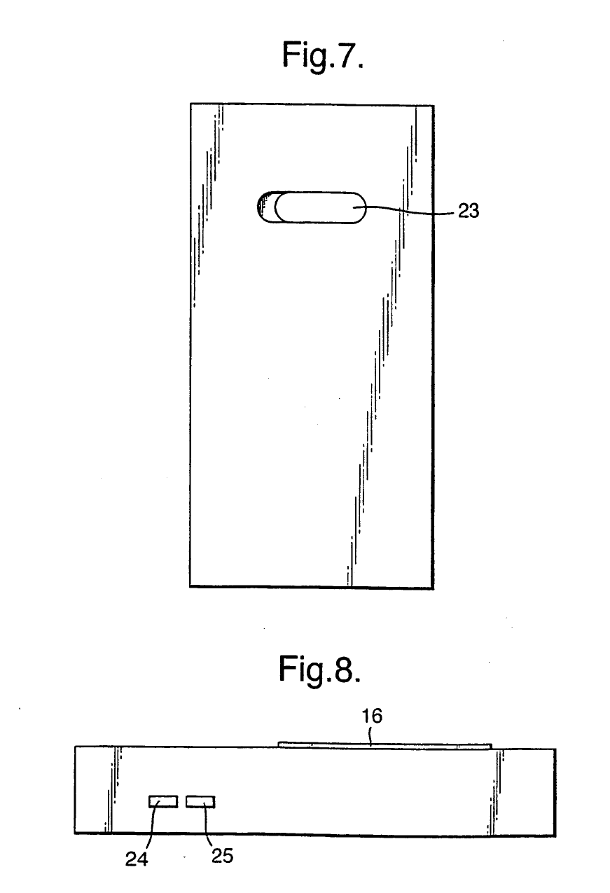

Within the housing 13, attached to the lower wall and extending longitudinally towards the upper wall is a spring loaded arm 21 that has a stud on its end. Referring to FIG. 9, when the core module is inserted into the casing module, the spring loaded arm 21 and stud interact with the stepped track 11 on the side of the core module housing 1 as part of the mechanism that will enable the core module to be connected securely to the casing module which will be described in more detail below. Referring again to FIG. 6, within the housing, on the rear face about a quarter of the length of the housing from its upper wall is a detent 22. Referring once again to FIG. 9, the detent 22 and the cylindrical stud 12 on the back of the core module interact as part of a further mechanism that will enable the core module to be connected securely to the casing module which will be described in more detail below. Referring to FIG. 7, the detent 22 can be operated by a user via a sliding catch 23 which is on the rear face of the housing 13 and is connected to the detent 22 through the housing 13. Referring to FIG. 8, on one of the side walls of the housing 13 there are two volume control keys 24 and 25 which act on the volume control switches 9 and 10 of the core module 1 when it is securely located within the casing module. Also attached to the lower wall (but not shown) and extending towards the upper wall is a spring. When the core module is securely located within the casing module. The core module abuts against and compresses the spring.

The mechanical connection between the core module and the casing module will now be described in more detail. Referring to FIG. 10, the stepped track 11 on the side of the core module housing I has an entrance 10a. Leading away from the entrance 10a in a straight line is upwardly sloping straight track section 10b. Half way along the straight track 10b is a first ridge 10c. After the first ridge 10c, the upwardly sloping straight track section continues to a second ridge 10d where the straight track section ends and a curved track section 10e begins. The curved track section 10e runs back in the opposite direction to the straight track section and merges with the straight track section near the entrance point 10a.

As described above, within the housing 13 of the casing module, attached to the lower wall and extending longitudinally towards the upper wall is a spring loaded arm 21 that has a stud on its end. To insert the core module into the casing module, a user inserts the core module into the casing module through a slot in the upper wall of the casing module and pushes the casing module into the core module. Upon pushing the core module into the casing module, the stud on the end of the spring loaded arm 21 enters the stepped track 10 at the entrance 10a and begins to run along the upwardly sloping straight track section 10b until it runs over the first ridge 10c. This causes the spring that is attached to the lower wall of the casing module to compress. At this point, a user inserting the core module into the casing module would hear and feel a ‘click’ informing them that the core module is securely connected to the casing module since the first ridge 10c prevents movement of the stud on the arm 21 back down the upwardly sloping straight track section 10b. To remove the core module from the casing module, the user pushes the core module further into the casing module. This causes the further compression of the spring in the casing module. The stud will continue to run along the upwardly sloping straight track section until it runs over the second ridge 10d. At this point the stud moves onto the curved track section 10e and begins to run back towards the entrance 10a. The spring begins to expand propelling the core module out of the casing module. The spring contains enough energy to propel the core module out of the casing module far enough to allow a finger grip on the top of the core module.

The above description of the mechanical connection of the core module to the casing module describes a push to insert, push to release type mechanism wherein the user pushes the core module into the casing module in order to connect the two together and then pushes the core module further into the casing module in order to remove the core module from the casing module. In order to prevent accidental ejection there is provided a secondary mechanism to secure the core module inside the casing module.

Referring to FIG. 11, the detent 22 consists of a sliding catch 26 that is attached via a spring 27 to a fixed support 28. The catch 26 is constrained to move linearly by a track 29. In its equilibrium position, the opposite end of the catch 26 to that attached to the spring 27 sits outside of the track 29. The end of the catch 26 that sits outside the track 29 in the equilibrium position has one flat edge and one sloping edge.

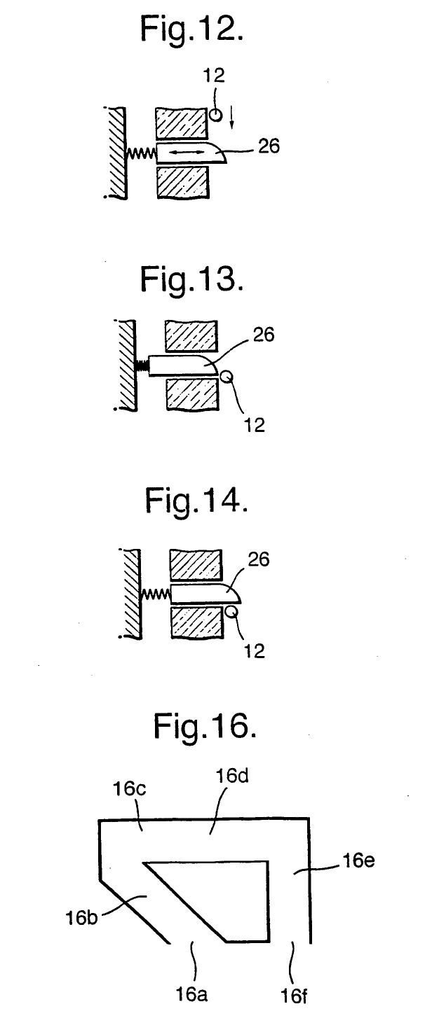

Referring to FIG. 12, as the core module is inserted into the casing module the cylindrical stud 12 moves towards the detent 22 until it makes contact with the sloping edge of the catch 26. Upon coming into contact with the sloping edge of the catch 26, the force exerted on the catch 26 will cause it to deflect in a direction perpendicular to the direction of insertion. Referring to FIG. 13, the catch 26 deflects enough so as to allow the stud 12 to pass by. Referring to FIG. 14, once the stud 12 has passed by the catch 26, it will spring back into its original position preventing the stud 12 from moving to where it came from and thus preventing removal of the core module from the casing module. (Contemporaneously with the stud 12 passing the catch 26, the stud on the end of the spring loaded arm 21 also passes the first ridge 10c in the stepped track 11 as described earlier.) In order to remove the core module from the casing module, the user must first slide the sliding catch 23 on the back of the casing module. This will cause the sliding catch 26 to move out of the way of the stud 12 since the sliding catch 23 is attached to the sliding catch 26. The stud will then be able to pass by the catch 26 enabling removal of the casing module. Removal of the casing module is then achieved via the push to insert, push to release mechanism described earlier.

It will be realised that the mechanical connection mechanisms described above are only examples of the many ways of connecting the core module to the casing module. In other embodiments, alternative mechanisms are possible and some of these are described below.

Instead of the secondary mechanism described above to secure the core module inside the casing module, in another embodiment the secondary mechanism comprises a track on the exterior rear wall of the core module in which a pin, located on the interior rear wall of the casing module, runs. In this embodiment the pin is connected through the rear wall of the casing module to a sprung sliding catch that a user can operate.

Referring to FIG. 16, the track comprises an entrance 16a to an angled track section 16b running away from the entrance 16a at an appropriate angle (e.g. approximately 45θ). A crosswise track section 16c, running perpendicular to the direction of insertion of the core module into the casing module, begins where the angled track section 16b ends. The mid-point of the crosswise track section 16d is in vertical alignment with the entrance 16a. The end of the crosswise track section 16c is at a junction with a longitudinal track section 16e running in the same direction as the direction of insertion of the core module into the casing module. The longitudinal track section runs towards an exit 16f which is in horizontal alignment with the entrance 16a.

As the core module is inserted into the casing module, the pin enters the track at the entrance 16a and begins to run along the angled track section 16b causing the spring of the spring loaded catch to expand. At the end of the core module's insertion trajectory the pin will enter the crosswise track section 16b, the spring will compress back to its equilibrium position and the pin will come to rest at the mid-point of the crosswise track section 16d. At this time, the core module is restrained from moving in the direction of its insertion by the walls of the crosswise track section 16c.

To remove the core module from the casing module, a user slides the sliding catch so that the pin moves along the crosswise track section 16c towards the longitudinal track section 16e. When it enters the longitudinal track section 16e the pin will move along the longitudinal track section 16e towards the exit 16f enabling removal of the core module from the casing module.

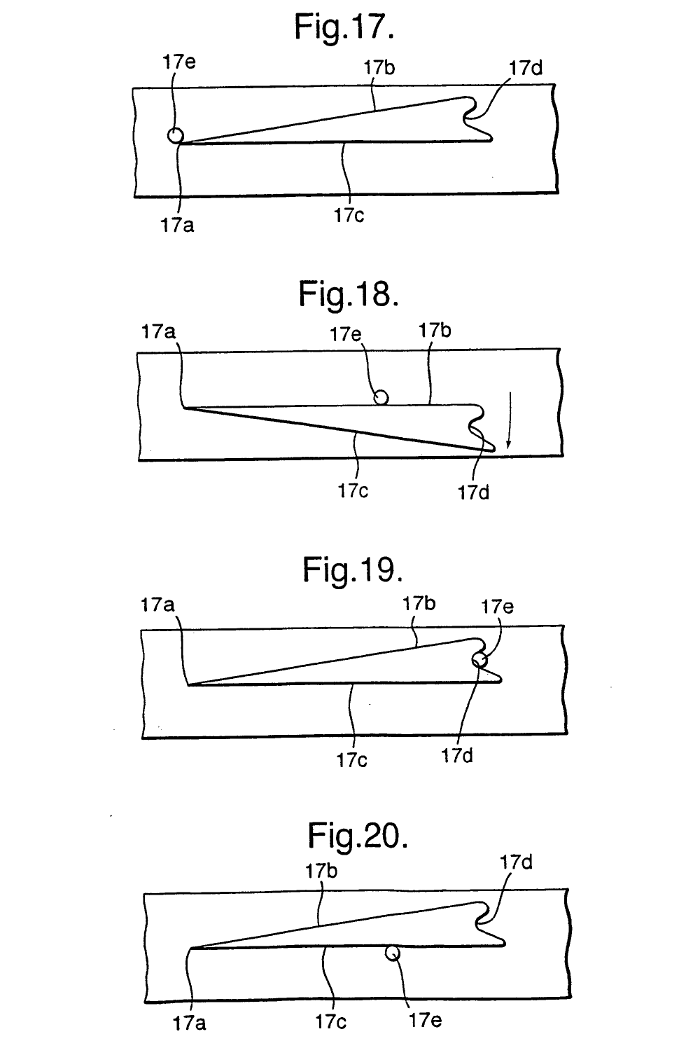

Instead of the stepped track described above, in another embodiment there is provided a pin fixed onto the exterior side wall of the core module and a sprung track on the interior side wall of the casing module. Referring to FIG. 17, the sprung track runs along the interior side wall of the casing module and is connected, at a connection point 17a, to the side wall at the end of the track nearest the upper wall of the casing module. The sprung track can pivot and rotate about this connection point 17a. The track has a top edge 17b and a bottom edge 17c. The top edge 17b and bottom edge 17c diverge with respect to the distance from the connection point. At the opposite end of the track the top edge 17b and bottom edge 17c both turn smoothly back towards the connection 17a point and meet to form a smooth groove 17d.

When the core module is inserted into the casing module, the pin 17e approaches the top edge 17b of the track. Referring to FIG. 18, as the core module is pushed further into the casing module the pin 17e runs along the top edge 17b of the track causing it to deflect and rotate about the connection point 17a. As the pin 17e passes the end of the top edge 17b of the track, the track can rotate back towards its equilibrium position. Referring to FIG. 19, before the track reaches its equilibrium position, the pin 17e comes to rest in the smooth groove 17d at which time the core module is securely connected to the casing module.

To remove the core module from the casing module, the user pushes the core module further into the casing module. This will cause the pin 17e to move past the end of the bottom edge 17c of the track allowing the track to complete its rotation back to its equilibrium position. Referring to FIG. 20, the pin 17e will then be able to run along the bottom edge 17b of the track enabling the removal of the core module from the casing module.

It will be realised that this mechanism is another example of a push to insert, push to release mechanism.

It will be realised that in alternative embodiments similar to the previous described embodiment, the track can be fixed on the side wall of the core module and a wire spring finger can provided on the side wall of the casing module. In such embodiments, the wire spring finger moves over the top and bottom edges of the fixed track deflecting as it does so.

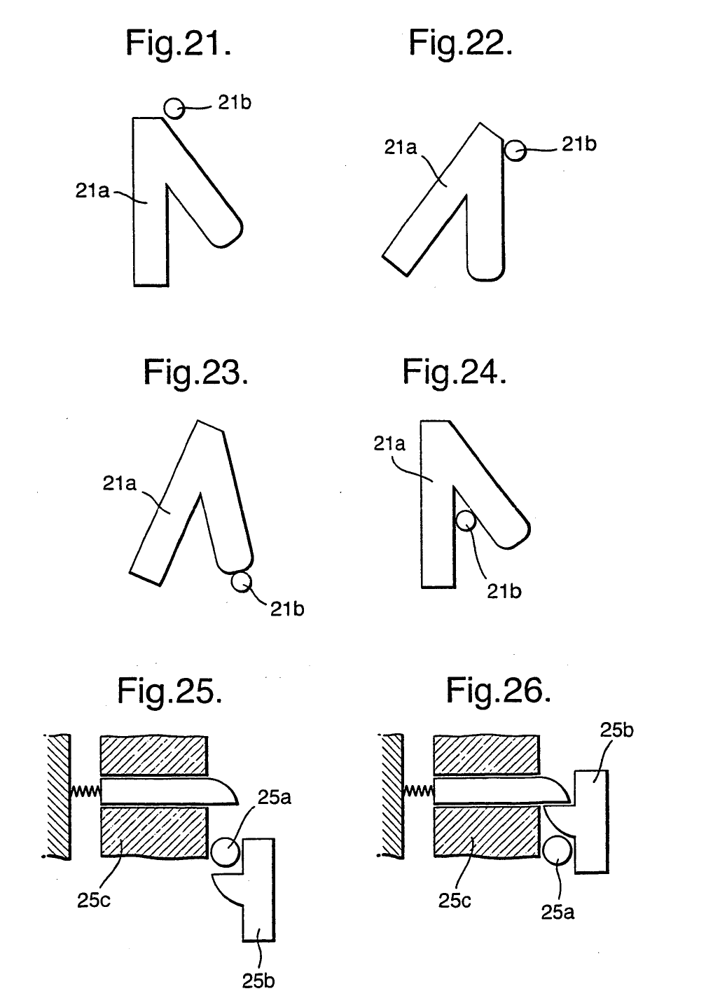

In another embodiment, there is provided a mechanism comprising a rotary latch mounted on the interior rear face of the casing module and a peg provided on the exterior rear face of the core module. The latch is connected to a rotary knob on the exterior rear face of the casing module for a user to operate the rotary latch. The rotary latch and rotary knob are sprung loaded enabling them to rotate about their equilibrium position. Referring to FIG. 21, the latch 21a is V-shaped. In its equilibrium position, one edge of the latch 21a points towards the lower wall of the casing module and the other edge of the latch 21a is at an angle (e.g. approximately 45θ).

Referring to FIG. 22, when the core module is inserted into the casing module, the peg 21b makes contact with the angled edge of the latch 21a causing it to rotate. The peg can then slide down the angled edge enabling the core module to slide into the casing module. Referring to FIG. 23, when the peg 21b passes the end of the angled edge, the latch 21a begins to rotate back to its equilibrium position. Referring to FIG. 24, once the latch 21a has returned fully to its equilibrium position, the peg 21b lies in between the two edges of the latch 21a. The peg cannot move towards the upper wall of the casing module and the core module is securely connected to the casing module.

To remove the core module from the casing module, the user rotates the rotary knob on the casing module exterior. This causes the peg to move back towards the lower wall of the casing module and past the end of the angled edge of the latch 21a, as in FIG. 23. The peg can then slide back up the angled edge, as in FIG. 22, enabling removal of the core module from the casing module.

In another embodiment, there is provided a detent similar to the detent 22 described above. The detent is fixed on the exterior rear face of the core together with a peg. On in the interior rear face of the casing module is provided a sprung rotating latch. The sprung rotating latch consists of a cuboid. Along one of the longitudinal faces of the cuboid there is a ledge that sticks out perpendicular to that face. The ledge has a straight top edge but a curved bottom edge.

Referring to FIG. 25, as the core module is inserted into the casing module, the peg 25a makes contact with the straight top edge of the ledge on the sprung rotating latch 25b. As the core module is pushed further inside the casing module the force the peg 25a exerts on the ledge causes the latch 25b to rotate. As the latch 25b rotates, the peg 25a can slide along the top edge of the ledge until it passes the end of the ledge at which point the latch 25b is able to spring back to its equilibrium position. Referring to FIG. 26, the latch is restrained from moving past its equilibrium position by the sliding catch 25c.

To remove the core module from the casing module the user pulls back the sliding catch 25c and pulls the core module out of the casing module. This causes the peg 25a to exert a force on the curved edge of the ledge causing the latch to rotate. The peg 25a slides along the curved edge of the ledge until it passes the edge of/the ledge enabling removal of the core module from the casing module.

The electrical connection between the core module 1 and the casing module 13 will now be described in more detail. In the present embodiment, the connectors 20 on the PCB 19 of the casing module take the form of sprung contacts. As the core module is inserted into the casing module, the sprung contacts deflect and wipe over a set of printed pads which form the connectors 4 on the PCB 5 of the core module. Once the core module is correctly in position, the sprung contacts press firmly on the printed pads thus forming the desired electrical link between the core module and the casing module. This link provides the path for any electrical signals that have to flow between the core module and the casing module for operation of the mobile telephone (e.g. power, data, audio signals etc.)

Separately, the core module and the casing module are rendered useless. The functionality of the mobile telephone is dictated by the combination of the core module and the casing module. The external appearance of the mobile telephone is dictated by the external appearance of the casing module. As long as the core module can be inserted and secured inside the casing module, the casing module can take any form or shape. Different casing modules allow different degrees of customisation to the mobile telephone.

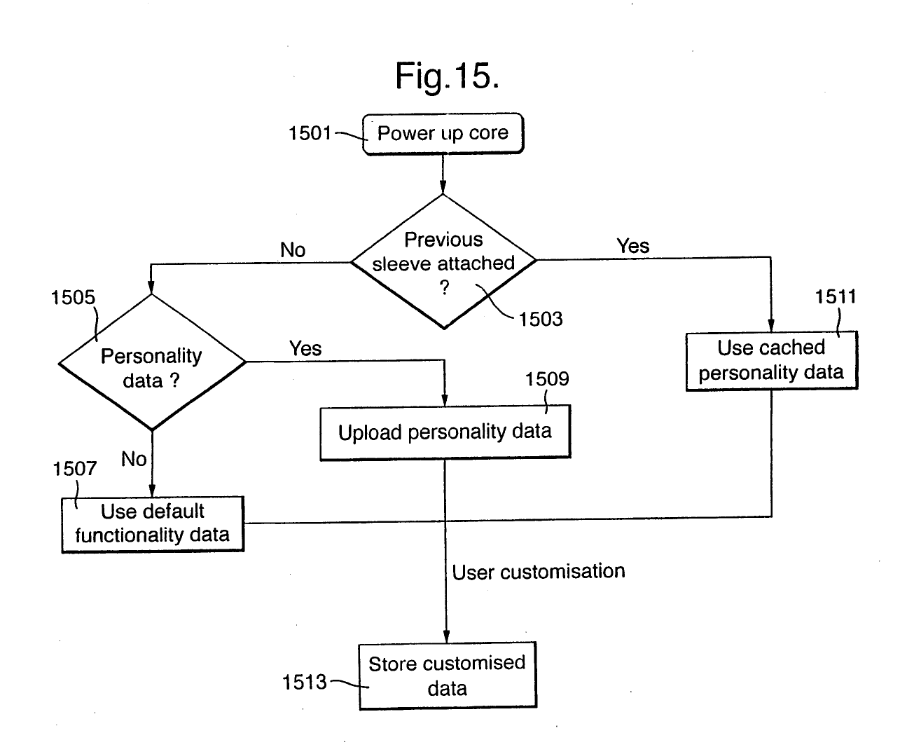

Referring to FIG. 15, upon inserting the core module into a suitable casing module and powering it up at step 1501, the core module first checks whether the casing module is the same casing module as it was previously connected to at step 1503. If it is not (as will be the case when the core is powered up for the first time, when it is powered up in a new casing module or when it is powered up in a different but previously used casing module) then a further check is made to see whether or not the new casing module contains any casing module personality data at step 1505. If it does not then the interface functionality data embedded in the core module's memory is cached and used at step 1507. The default interface functionality data embedded in the core module includes some user interface elements which are fixed and cannot be changed. Examples of such user interface elements include idle screen indications (e.g. signal strength, battery level and keypad lock), menu presentation (e.g. colour and alignment), call handling screens (e.g. call in progress and call waiting), visual and auditory event indications (e.g. alarms and appointment/reminder alerts), message related indications (e. sending message, and message sent) and core module based functionality top level menu icons which are preferably used as shortcuts to the core module embedded functionality. The default interface functionality data embedded in the core module also includes some data files that can be used to customise some of the user interface elements. Examples of the user interface elements that can be customised with suitable data files include ringtone melodies, idle screen background/wallpapers, text size, menu graphics, background themes and message received tones. If a user chooses to customise one of these interface elements then there changes are cached in the memory of the core module at step 1513. If the new casing module does contain casing module personality data then it is uploaded to the core module at step 1509 and cached in the core module's memory. Any previously cached data is preferably overwritten and removed to avoid any possible conflicts. If, however, the casing module is the one that the core module had previously been inserted in to, then the previously cached casing module personality data is used at step 1511. The cached casing module personality data files can be used to further customise some of the user interface elements of the mobile telephone. Examples of the user interface elements that can be customised by a user with suitable casing module personality data file include idle screen backgrounds/wallpapers, menu backgrounds/theme, power on/of melodies, new message indication, audible message alert tones, incoming call graphics/animations/backdrops, casing module based functionality top level menu icons, screensavers/low power modes. In preferred embodiments, a user will also be able to access additional casing module personality data files from sources such as the Internet or premium rate telephone services for download via WAP, SMS, EMS or MMS for example. In other embodiments it is also possible to restrict the functionality of the mobile telephone. In one such embodiment, the mobile telephone would only be capable of making outgoing calls or sending messages to a set of predefined numbers and/or at pre-defined times of day. This could be achieved wither by pre-programming the core module or the casing module or both.

An authentication protocol to authenticate only suitable casing modules could also be included in between step 1501 and step 1503. One example of such a protocol would be to code each casing module with a unique identification code. On inserting the core module into a casing module, the core module sends out an authentication request, containing the sleeve identification code, to a central registry. The registry checks if the casing module identification code is valid and if the check is passed sends out an authentication response. The core module will then continue to operate within the casing module. If the core module receives a rejection from the registry, or fails to receive any response within a predefined time, it will cease to operate in the casing module and will display a predetermined message for a defined time (e.g. 10 seconds) and then power off.

Other casing modules, which may or may not contain casing module personality data, may also contain some added functionality. In the following descriptions of embodiments possessing the possible added functionality, it is assumed that suitable functional circuitry is provided within one or both of the casing module and/or the core module to enable the mobile telephone to operate with the described added functionality.

In one embodiment, when a core module is inserted into an appropriate casing module, the mobile telephone becomes capable of operation as part of an ad hoc short range wireless interconnectivity system such as the system developed under the trademark Bluetooth™, Bluetooth™ uses radio interfaces in the 2.45 GHz frequency band to allow suitably equipped portable electronic devices to connect and communicate wirelessly via short-range ad hoc networks. This system is designed to replace cables between portable consumer devices such as mobile telephones, headsets, laptop computers, personal digital assistants, digital cameras, and many other products. The Bluetooth™ system is described in Ericsson Review No 3, 1998, Jaap Haartsen, “BLUETOOTH—The Universal Radio Interface for Ad Hoc, Wireless Connectivity”. Such networks are referred to in that article as “piconets”. Furthermore, a Bluetooth™ base station could be provided which would allow voice and data communications between the mobile telephone and a public switched telephone network (PSTN), a integrated services digital network (IDSN) or a digital subscriber line (DSL) for example.

In another embodiment, when a core module is inserted into an appropriate casing module, the mobile telephone becomes capable of operation as a radio. The existing core module display is preferably used to display relevant tuning and volume data. Moreover, the radio is preferably controlled via a normal telephone keypad or alternatively the casing module is designed so that there are designated keys to control the radio.

In another embodiment, when a core module is inserted into an appropriate casing module, the mobile telephone becomes capable of operation as a Global Positioning System (GPS) receiver. The existing core module display is preferably used to display relevant positional data. It may be desirable, in such an embodiment, to encase the core functional module in the casing module for use in an outdoor environment. This would protect the core functional module from any damage that could be caused to it by exposure to a shock or to moisture/water.

In another embodiment, when a core module is inserted into an appropriate casing module, the mobile telephone becomes capable of operation as a compass or an altitude or temperature sensor with the core module's display preferably being used to display the bearing, height or temperature. It may again be desirable, in such an embodiment, to enclose the core functional module in the casing module for the reasons described above.

In another embodiment, when a core module is inserted into an appropriate casing module, the mobile telephone becomes capable measuring certain body characteristics such as heart rate, blood pressure or blood sugar level with the core module's display preferably being used to display the measured characteristic.

In another embodiment, when a core module is inserted into an appropriate casing module, the mobile telephone becomes capable of operation as a gaming pad enabling a user to play a variety of games. In this embodiment, additional keys or even a small joystick are preferably provided on the keypad to enhance gaming. The gaming software is preferably written in the Java 2 Micro-Edition (J2ME) programming language although an other suitable programming language can be used. Moreover, the gaming software is preferably stored in the casing module's memory and uploaded to the core for execution. Furthermore, in gaming mode, the mobile telephone is preferably operated in an orientation perpendicular to the normal orientation used to make and receive telephone calls.

In another embodiment, when a core module is inserted into an appropriate casing module, the mobile telephone becomes capable of operation as an MP3 player. In this embodiment the core module's display is preferably used to display the currently playing MP3 file. Moreover, additional memory (e.g. in the form of customer installable memory cards) could be provided in the casing module for storage of MP3 files. Furthermore, the player is preferably controlled via a normal telephone keypad or alternatively the casing module is designed so that there are designated MP3 player control keys.

In another embodiment, when a core module is inserted into an appropriate casing module, the mobile telephone becomes capable of operation a digital camera. In this embodiment the core module's display is preferably used to display the pictures taken. Moreover, additional memory (e.g. in the form of customer installable memory cards) is preferably provided in the casing module for storage of pictures. Furthermore, the camera is preferably controlled via a normal telephone keypad or alternatively the casing module is designed so that there are designated camera control keys.

In another embodiment, the core module is inserted into a casing module designed as an in-car adaptor mounted in a suitable position in a car. This casing module preferably interfaces with a car stereo to mute the stereo during telephone calls, preferably charges the core module's battery and preferably contains a speaker for hands free operation. Furthermore, it preferably contains voice recognition ability and/or a voice synthesiser to aid hands free operation.

In another embodiment, the casing module includes a QWERTY keyboard instead of a normal keypad, preferably in an orientation perpendicular the normal orientation used to make and receive telephone calls.

In another embodiment, the core module or the casing module provides e-mail capability supporting the POP3, SMTP and IMAP4 protocols. Additional memory is preferably provided in the casing module for the storage of e-mail messages.

In another embodiment, when a core module is inserted into an appropriate casing module, the mobile telephone becomes capable of operation as a web browser supporting WAP, WML/WML script or HTML. The core module's display is preferably used to display the web pages. Moreover, browsing is preferably controlled via a normal telephone keypad or alternatively the casing module is designed so that there are designated browser keys.

In another embodiment, when a core module is inserted into an appropriate casing module, the mobile telephone becomes capable of operation as a personal information manager including, for example, a calendar and a to-do-list. In this case the core module's display is preferably to display the appointment information and tasks to do. Moreover, additional memory could be provided in the casing module for storage appointment information and tasks to do.

It will be appreciated that one casing module could provide none, some, or all of the added functionality described in the above embodiments.

Although the foregoing description relates to a GSM or a GPRS mobile telephone, it will be appreciated that aspects of the invention can also be implemented to create a 3^{rd} generation (3G) mobile telephone.

It will also be realised that any component described above as being positioned in the core module, could also be positioned in a casing module and vice versa.

It will also be appreciated that the illustrated embodiments are by way of example to illustrate various ways in which the aspects of the invention may be implemented, and are not intended to be limiting. Many alternative embodiments will be apparent to one skilled in the art.

1. A mobile telephone comprising:
a core functional module, said core functional module including one or more of a group of functional components necessary for operation as a mobile telephone, said group including logic circuitry, radio transmitting and receiving circuitry and audio transmitting and receiving circuitry, and
a casing module which can be combined with the core functional module, wherein circuitry is associated with the casing module and wherein when the core functional module is combined with the casing module, the circuitry of the core functional module will be connected to circuitry associated with the casing module, and wherein the appearance of the mobile telephone is dictated by the appearance of the casing module, and wherein the functionality of the mobile telephone is dictated by the circuitry of the core module and the circuitry associated with the casing module.

2. A mobile telephone according to claim 1 wherein said casing module can be combined with said core functional module by inserting said core functional module into said casing module.

3. A mobile telephone according to claim 1 wherein when the core functional module is combined with the casing module, the casing module surrounds the core functional module.

4. A mobile telephone according to claim 3 wherein said casing module surrounds said core functional module on at least four sides of said core functional module.

5. A mobile telephone according to claim 1 wherein the appearance of the mobile telephone is substantially dictated by the appearance of said casing module.

6. A mobile telephone according to claim 1 wherein the appearance of the mobile telephone is solely dictated by the appearance of said casing module.

7. A mobile telephone according to claim 1 wherein said core functional module is spring-loaded in said casing module.

8. A mobile telephone according to claim 1 wherein the circuitry of the core module and/or the circuitry associated with the casing module restricts the functionality of the mobile telephone.

9. A mobile telephone according to claim 1 further comprising circuitry in one or both of the core functional module and/or the casing module to enable operation of the mobile telephone as a radio.

10. A mobile telephone according to claim 1 further comprising circuitry in one or both of the core functional module and/or the casing module to enable operation of the mobile telephone as an MP3 player.

11. A mobile telephone according to claim 1 further comprising circuitry in one or both of the core functional module and/or the casing module to enable operation of the mobile telephone as a digital camera.

12. A mobile telephone according to claim 1 further comprising circuitry in one or both of the core functional module and/or the casing module to enable operation of the mobile telephone as a personal information manager.

13. A mobile telephone according to claim 1 further comprising circuitry in one or both of the core functional module and/or the casing module to enable operation of the mobile telephone as a GPS receiver.

14. A mobile telephone according to claim 1 further comprising circuitry in one or both of the core functional module and/or the casing module to enable operation of the mobile telephone as a compass.

15. A mobile telephone according to claim 1 further comprising circuitry in one or both of the core functional module and/or the casing module to enable operation of the mobile telephone as a temperature sensor.

16. A mobile telephone according to claim 1 further comprising circuitry in one or both of the core functional module and/or the casing module to enable operation of the mobile telephone as an altitude sensor.

17. A mobile telephone according to claim 1 further comprising circuitry in one or both of the core functional module and/or the casing module to enable the mobile telephone to send and receive e-mail messages.

18. A mobile telephone according to claim 1 further comprising circuitry in one or both of the core functional module and/or the casing module to enable operation of the mobile telephone as an internet browser.

19. A mobile telephone according to claim 1 further comprising circuitry in one or both of the core functional module and/or the casing module to enable operation of the mobile telephone as part of a Bluetooth system.

20. A mobile telephone according to claim 1 further comprising circuitry in one or both of the core functional module and/or the casing module to enable operation of the mobile telephone as a gaming pad.

21. A mobile telephone according to claim 1 further comprising circuitry in one or both of the core functional module and/or the casing module to enable operation of the mobile telephone as a body characteristic measuring device.

22. A mobile telephone according to claim 1 further comprising respective circuitry in one or both of the core functional module and/or the casing module to enable operation of the mobile telephone as any one or more of the following group of devices: a radio, a digital camera, a personal information manager, a GPS receiver, a compass, a temperature sensor, an altitude sensor, a device to send and receive e-mail messages, an internet browser, a Bluetooth enabled device, a gaming pad, a body characteristic measuring device.

23. A casing module for a mobile telephone, the casing module being adapted to cooperate with a core functional module, the core functional module including one or more of a group of functional components necessary for operation as a mobile telephone, said group including logic circuitry, radio transmitting and receiving circuitry and audio transmitting and receiving circuitry, wherein circuitry is associated with the casing module and wherein the casing module can be combined with the core functional module to create a mobile telephone, and wherein when the casing module is combined with the core functional module the circuitry associated with the casing module will be connected to circuitry of the core module, and wherein the appearance of the mobile telephone is dictated by the appearance of the casing module, and the functionality of the mobile phone is dictated by the circuitry of the core module and the circuitry associated with the casing module.

24. A core functional module for a mobile telephone, the core functional module including one or more of a group of functional components necessary for operation as a mobile telephone, said group including logic circuitry, radio transmitting and receiving circuitry and audio transmitting and receiving circuitry, wherein the core functional module can be combined with a casing module to create a mobile telephone, and wherein when the core functional module is combined with the casing module, the circuitry of the core functional module will be connected to circuitry associated with the casing module, and wherein the appearance of the mobile telephone is dictated by the appearance of the casing module, and the functionality of the mobile phone is dictated by the circuitry of the core module and the circuitry associated with the casing module.

25. An interconnect mechanism comprising a first member and a second member, the first member and/or second member being movable in a respective direction with respect to the other to an interconnected position wherein the first member is interconnected with the second member and then subsequently to a release position wherein the first and second members are releasable from each other.

26. An interconnect mechanism according to claim 26 wherein, in use, the first member and/or second member move directly to the interconnected position without moving beyond the interconnected position.

27. An interconnect mechanism according to claim 25 wherein said direction is a linear direction.

28. A mobile telephone comprising a first module, a second module and an interconnection mechanism according to claim 25, wherein said interconnection mechanism is operable to interconnect said first module and said second module.

29. A mobile telephone according to claim 28 wherein said first module includes said first interconnect member and said second module includes said second interconnect member.

30. A mobile telephone according to claim 28 wherein said second module includes said first interconnect member and said first module includes said second interconnect member.

31. A mobile telephone according to claim 28 wherein said mobile telephone comprises:
a core functional module, said core functional module including one or more of a group of functional components necessary for operation as a mobile telephone, said group including logic circuitry, radio transmitting and receiving circuitry and audio transmitting and receiving circuitry, and
a casing module which can be combined with the core functional module,
wherein circuitry is associated with the casing module,
wherein when the core functional module is combined with the casing module, the circuitry of the core functional module will be connected to circuitry associated with the casing module,
wherein the appearance of the mobile telephone is dictated by the appearance of the casing module,
wherein the functionality of the mobile telephone is dictated by the circuitry of the core module and the circuitry associated with the casing module, and
wherein said first module comprises said core functional module and said second module comprises said casing module.

32. A mobile telephone comprising a core functional module which includes the functional components necessary for operation as a mobile telephone including logic circuitry, radio transmitting and receiving circuitry and audio transmitting and receiving circuitry, and a removable casing module in which the core functional module is received, characterised in that circuitry is associated with the casing module and is connected to circuitry of the core module, so that the appearance of the mobile phone is dictated by the appearance of the casing module, and the functionality of the mobile phone is dictated by the circuitry of the core module and the circuitry associated with the casing module.

33. A method for creating a mobile telephone in which a core functional module is provided which includes the functional components necessary for operation as a mobile telephone including logic circuitry, radio transmitting and receiving circuitry and audio transmitting and receiving circuitry, and there is provided a casing module which is combined with the core functional module to create a complete mobile telephone, characterised in that circuitry is associated with the casing module and when the casing module is combined with the core functional module the circuitry associated with the casing module is connected to circuitry of the core module, so that the appearance of the mobile phone is dictated by the appearance of the casing module, and the functionality of the mobile phone is dictated by the circuitry of the core module and the circuitry associated with the casing module.

34. A core functional module for a mobile telephone, the core functional module including functional components necessary for operation as a mobile telephone including logic circuitry, radio transmitting and receiving circuitry and audio transmitting and receiving circuitry, and the core functional module being adapted to cooperate with a casing module so that the casing module can be combined with the core functional module to create a complete mobile telephone, characterised in that circuitry in the core functional module is adapted to be connected to and to cooperate with circuitry associated with the casing module so that when the casing module is combined with the core functional module the functionality of the resultant mobile phone is dictated by the circuitry of the core module and the circuitry associated with the casing module.

35. A casing module for a mobile telephone, the casing module being adapted to cooperate with a core functional module which includes the functional components necessary for operation as a mobile telephone including logic circuitry, radio transmitting and receiving circuitry and audio transmitting and receiving circuitry, so that the casing module can be combined with the core functional module to create a complete mobile telephone, characterised in that circuitry is associated with the casing module so that when the casing module is combined with the core functional module the circuitry associated with the casing module will be connected to circuitry of the core module, so that the appearance of the mobile phone is dictated by the appearance of the casing module, and the functionality of the mobile phone is dictated by the circuitry of the core module and the circuitry associated with the casing module.
